(19) United States
(12) Patent Application Publication
(10) Pub. No.: US 2004/0134369 A1
(43) Pub. Date: Jul. 15, 2004

(54) Apparatus and method of printing a document having variable text data and graphics data

(76) Inventor: Richard East, Oregon City, OR (US)

Correspondence Address: Steven J. Adamson, PC, P.O. Box 5997, Portland, OR, 97228, US

(21) Appl. No.: 10/342,118

(22) Filed: Jan. 13, 2003

(51) Int. Cl. G06K 3/00

(52) U.S. Cl. 101/483

(57) ABSTRACT

A method and apparatus of producing a printed document having variable text data and graphics data components. Database entrants are retrieved from a database based on specified parameters to create a variable text data file. This variable text data file may be combined with a non-variable text data file. The variable text data file is combined (with or without a non-variable component) with a graphics file and each combination of individual entrant data and the graphics file is printed in a single print operation. Several embodiments are disclosed.

### FIELD OF THE INVENTION

The present invention relates to printing documents that contain variable text data and graphics data in a single print operation. The present invention also relates to data retrieval and management prior to printing.

### BACKGROUND OF THE INVENTION

Programs that combine variable text data such as customer contact information with non-variable text data such as a form letter are known in the art. These programs are typically referred to as “mail merge” programs and are provide in some capacity in most commercial word processing software.

To produce a document having both graphics data and variable text data (e.g., unique customer or “mail-merge” data) using prior art techniques, the graphics data and the variable text data are printed in two separate print operations. For example, the graphics component may be printed first, then the variable text data is printed on to the “pre-printed” graphics containing sheet. Alternatively, variable text data could be printed first followed by graphics data.

One reason for the failure of prior art devices to combine variable text data and graphics data for printing in a single print operation is that combining these files results in very large file sizes, too large for adequate processing by prior art machines.

For example, a variable text file of 1000 names and a non-variable text data file of a standard form letter or template may produce a mail-merge file of several hundred MB. An individual graphics file for an 8.5×11 or 8.5×14 page may be 1-4 MB. Combining this graphics file with each mail-merge document has a multiplicative effect on file size, often resulting in a combined file that is too large for timely printing on conventional printing systems. Accordingly, prior art techniques rely on multiple print operations to provide documents having graphics data and variable text data on the same page.

This reliance on multiple print operations is disadvantageous for many reasons, including that it takes more time and consumes significantly more energy than a single print operation. In addition, it increases the potential for mechanical failure such as printer misalignment or paper jamming, etc. All of these factors contribute to increased cost of production. Requisite multiple printing operations may also reduce the flexibility of a designer in creating documents.

A need thus exists for producing, in a single print operation, documents that have both variable text data and graphics data. A need also exists for producing such documents at a commercially acceptable throughput rate and at reasonable prices.

### SUMMARY OF THE INVENTION

The present invention overcomes the limitations of the prior art by uniquely retrieving and processing data to produce documents in a single print operation that have both a variable text data component and a graphics data component.

The present invention involves data storage and retrieval in a manner that permits ready selection of a desired number of customers (or other database entrants) based on desired parameters. These parameters may include, but are not limited to or do not necessarily include, time, location, distance and/or other parameters. Retrieved data is a variable data file. This variable data file may be combined with non-variable data such as vendor information or other to form merged or otherwise combined documents. The merged documents may then be combined with a specified graphics file to achieve unique, targeted, high-quality graphics containing documents in a single print operation.

In one embodiment, the present invention includes a method of producing a printed document that comprises the steps of: retrieving from a database a plurality of entrants based on a given parameter to create a variable text data file; combining that variable text data file with a graphics file in such a manner as to create a plurality of electronic files that each contain data for one of said retrieved entrants and said graphics file; and printing, in a single print operation, each of the plurality of electronic files.

Various other embodiments of the present invention are discussed below.

The attainment of the foregoing and related advantages and features of the invention should be more readily apparent to those skilled in the art after review of the following more detailed description of the invention taken together with the drawings.

### BRIEF DESCRIPTION OF THE DRAWINGS

FIG. 1 is a diagram of a representative marketing flier made in accordance with the present invention.

FIG. 2 is a diagram of a vendor template in accordance with the present invention.

FIG. 3 is a diagram of a customer data table retrieved from a customer database in accordance with the present invention.

FIG. 4 is a flow diagram of data extraction from a database in accordance with the present invention.

FIG. 5 is a schematic diagram of a system for retrieving data and printing a document having variable text data and graphics data in accordance with the present invention

FIG. 6 is a flow diagram for a method of printing a document containing variable text data and graphics data in accordance with the present invention.

FIG. 7 is a diagram of one example of both human and machine-executable steps involved in producing a document having variable text data and graphics data in accordance with the present invention.

### DETAILED DESCRIPTION

The present invention may be implemented or manifested in many ways. One of these is in producing targeted sales or “marketing” fliers that are made for client vendors for promoting goods or services to targeted customers. By way of example and for pedagogical purposes, a first implementation is now presented in which a flier is produced for use in selling automobiles to individuals emerging from bankruptcy. Rebuilding credit is a primary concern for these individuals and buying a car on credit is a well recognized manner of rebuilding credit.

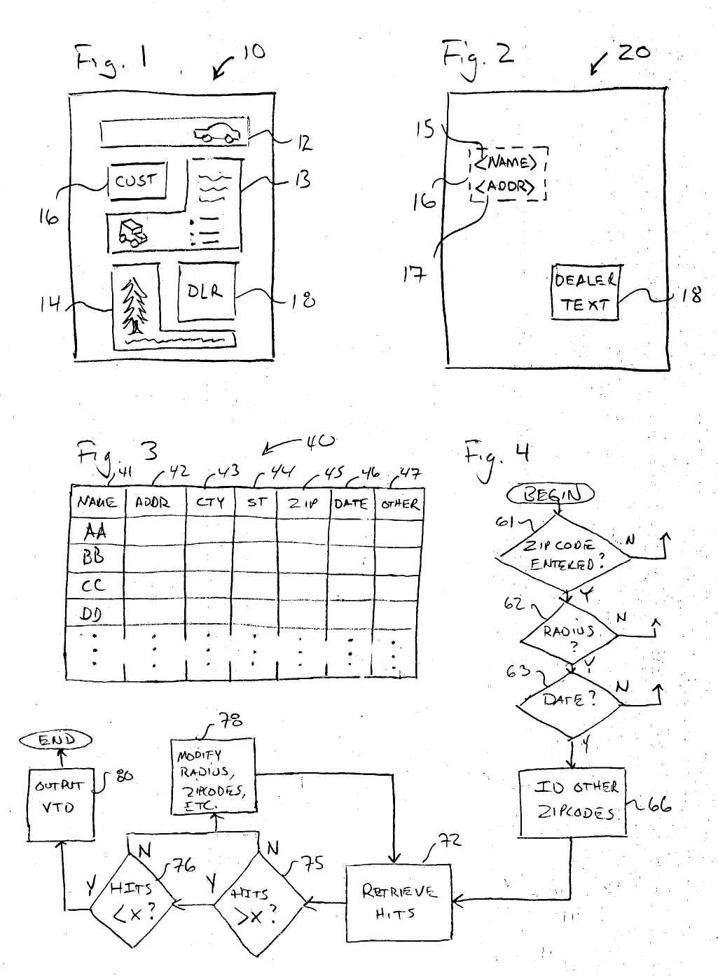

Referring to FIG. 1, a diagram of a representative marketing flier 10 made in accordance with the present invention is shown. Flier 10 includes graphics elements 12-14, a variable data block containing customer data 16 and a vendor or dealer block containing dealer information 18. While flier 10 is for selling vehicles to targeted customers it should be recognized that this is merely one of many arrangements and/or uses of the present invention.

Initially, a mock-up of flier 10 is made, preferably in desktop publishing software or the like. One suitable program is Illustrator by Adobe. Once a design having dealer information, customer data fields and desired graphics elements is approved, the customer and dealer data are removed, leaving the graphics file which may contain images, text, colored segments, background patterns and/or other elements. The graphics file may be stored as a .pdf file or other suitable file format for later retrieval and use as discussed below. The customer and dealer data are subsequently provided via a dealer template.

While flier 10 may be formed in a plurality of ways, one manner of forming flier 10 is as follows. A Word Template file 20 (shown in FIG. 2) is created that includes dealer block 18 and customer block 16 (provided in appropriate locations for subsequent overlay on graphics data). Dealer block 18 contains desired dealer information such as dealer name, sales associates, contact information, and/or promotional notes, etc. Data in block 18 is non-variable text data. In customer block 16, fields are defined for receipt of variable text customer data. These fields may include a name field 17 and an address field 19, among other fields. Note that fields 17,19 are merely representative. Other fields may be provided, and name and address fields may be broken down into sub-components (e.g., first name, last name, street address, city, state, zip, etc.) as is known.

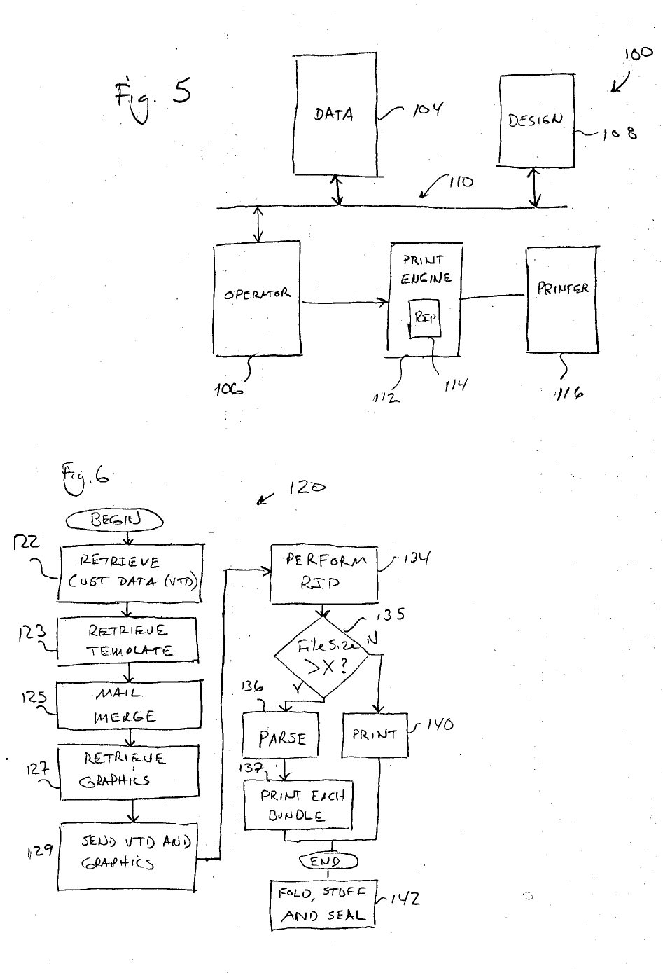

Desired variable text data is then provided, for example, as discussed below with reference to FIGS. 3-4. A mail merge or like program is preferably used to combine the variable text customer data with dealer template 20 to create a plurality of variable text data containing files which are termed, for purposes of the present discussion, “merged documents.” When using a Word Template as the dealer template, the merged documents are preferably stored as Word documents (.doc). Next, each of the merged documents is overlayed on the desired graphics file using raster image processing (RIP) or other suitable techniques. This process, discussed in more detail below, creates a plurality of individually targeted variable data containing graphics files which may be printed in a single print operation. The process of flier formation is now discussed in more detail.

Referring to FIG. 3, a diagram of a representative customer data table 40 retrieved from a customer database in accordance with the present invention is shown. Note that while the term “customer” is used in this example, the present invention may be practiced with database entrants that are not traditionally designated as “customers,” for example, the entrants could be invitees, members of a given audience or the general public, etc.

Customer data is available from many sources, including via purchase from commercial sources and via download from public databases, among other methods. In the present example, retrieved bankruptcy customer data is preferably stored as a text file and may take the form shown in table 40 which includes fields for name 41, address 42, city 43, state 44, zip code 45, date of bankruptcy filing 46 and other 47. The “other” data may include an “in-use” designation (so that fliers are not sent to the same customer from competing client vendors), date of discharge from bankruptcy, dealers from whom the customer has received a flier, or other information. With a certain frequency, daily, weekly, monthly, etc., new customers are preferably added to the database. After a certain period of time, customers may be purged from the database. This database may be maintained on a SQL server that is attached via Access or another suitable database program.

Referring to FIG. 4, a flow diagram 60 of data extraction from a database in accordance with the present invention is shown. The extracted data is variable text data that is intended to provide a list of persons, i.e., customers, who have filed bankruptcy within a given period and are located a given distance from a client dealer. Note that bankruptcy courts have an average time period to discharge, and if, for example, that time is 16 weeks, then sending a flier 12 or 14 weeks after filing is likely to reach a customer just before discharge. Fliers may be sent at any time and multiple fliers may be sent to the same customer.

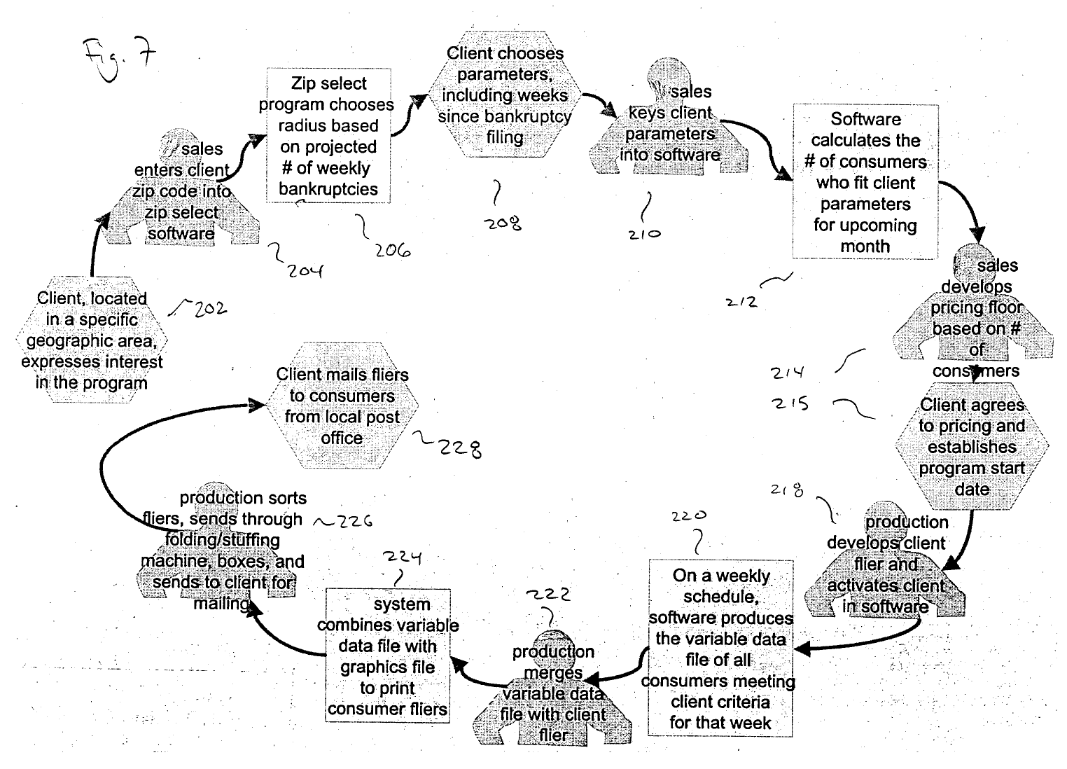

In use (and preferably in conjunction with system 100 of FIG. 5), an operator enters the zipcode of a client dealer, a radius for potential customers and a range of weeks after filing (for example, 12-18) at which the client dealer wants a marketing piece sent (steps 61-63). Note that other parameters such as weeks after discharge, etc., could alternatively be used. Other zipcodes within the chosen radius are then determined (step 66). This may be achieved via zip select software that is available commercially. Note that all entrants in the database preferably have an associated in-use tag. This tag is set when the entrant is retrieved as part of a data retrieval operation. This tag preferably remains set for a fixed period of time, for example, two weeks or other, so that a flier is not sent to the same customer at approximately the same time from competing client dealers. Customers meeting the specified parameters are then retrieved (step 72).

A determination is then made as to the number of customers retrieved to assure that it is over a minimum and does not exceed a maximum (steps 75-76). Note that providing a definable or “certain” number of customer leads, for example, 200 at a given moment of time, aids in pricing flier generation. If not enough customers are retrieved than the range of weeks after filing may be expanded and/or more zipcodes may be added. If a significant overage of customers occurs, then either the price to client may be increased or the range of weeks or number of zipcodes may be reduced, etc. (step 78). When a number of “hits” is found that is within a desired range, the corresponding customer data is output as a variable text data file (step 80) that may be arranged as in table 40. This file may be stored as a plain text (extension .txt) file.

Referring to FIG. 5, a schematic diagram of a system 100 for retrieving data and printing documents having both variable text data and graphics data in accordance with the present invention is shown. System 100 may include a database server 104 and an operator work station computer 106 coupled via a network or the like 110. Database computer 104 is preferably a SQL server. The operator computer may run Microsoft Access to attach to the SQL server. Dealer information, customer data and graphics files are resident on database server 104. It should be noted that FIG. 5 illustrates only one representative arrangement and other computer and network arrangements would be apparent to one skilled in the art given the teachings herein.

The graphics component of the flier may be designed at a separate “design” computer 108 or at operator computer 106. The graphics file may be for a 8.5×11 or 8.5×14 sheet or any other desired size.

A print engine 112 and color printer 116 are preferably provided downstream of computer 106. The engine 112 preferably provides “raster image processing” or RIP software 114. A suitable print engine that supports RIP operation is the Micropress made by TR Systems. Printer 116 preferably provides high throughput quality color printing. A suitable printer is the Color Laser Copier (CLC) 5000 made by Canon. Note that while RIP processing is preferred, other image processing techniques that combine variable text data and graphics data for printing in a single print operation is within the present invention.

Referring to FIG. 6, a flow diagram 120 for printing, in a single print operation, a document that combines variable text data file and a graphics data file in accordance with the present invention is shown. As mentioned above, the client dealer template or other type of “form letter” (20 of FIG. 2) is provided that preferably contains both client dealer information and fields for variable text customer data. The template indicates the proper positioning on a page of the client dealer data and customer data.

To begin a flier generation cycle, an operator retrieves customer data from database computer 104 based on specified parameters (step 122). An example of data retrieval is provided with reference to FIG. 4. The operator also retrieves the desired dealer template (20 of FIG. 2) (step 123). Note that the order of steps 122,123 can be reversed. A merge program (step 125) is then invokes that creates a plurality of uniquely addressed merged documents, one for each customer retrieved from the database. The merged documents may be saved as Word documents. Using file size from an actual production run as an example, if the customer data has approximately 100 names then the resultant merged documents file may be approximately 60 MB.

The desired graphics file is then retrieved (step 127). The graphics file is preferably in .pdf format. Following the present example, it may have a file size of 2.5M. The merged documents (containing the variable text customer data) and the graphics file are sent to the print engine 112 (step 129). A RIP operation is then executed, controlled via the user interface of the print engine, to overlay each merged document on the designated graphics file (step 134). In this RIP operation, the text data of each of the merged documents in combined with the graphics file to create a plurality of documents that each contain graphics, vendor text and uniquely targeted customer text.

The file after the RIP operation is the same number of pages as before, i.e., contains the same number of fliers (approximately 100 in the current example), but has increased in file size from approximately 60 MB to 500 MB. If, for example, the number of customers and hence the number of fliers were 1,000, then the file size may similarly increase 10 fold or more.

The maximum file size for printing that is permitted by Windows is 4 GB. If file sizes are likely to approach this size, then functionality provided in the print engine unit is preferably enabled to parse the RIPed file into smaller sized bundles. Thus, either electronically or though operator inquiry, the size of the RIPed file is investigated (step 135). If the file size exceeds a specified threshold (step 136), then the file is parsed into smaller bundles of pages for printing. For example, a file size over or approaching 4 GB may be parsed into bundles of 200 pages or another size as appropriate (step 137), so that printing may still be achieved within the constraints of a Windows operation system, and with commercially acceptable throughput. If the file size does not exceed a given threshold, then it may be printed without parsing (step 140).

Once printed, the fliers may be proofed and then folded and stuffed into envelopes, and the envelopes sealed (step 142). Suitable equipment for these latter steps is commercially available from Pitney-Bowes and other sources. Note that step 142 is provided after the END designation because step 142 is not carried out by the system shown in FIG. 5, but on separate equipment.

Referring to FIG. 7, a diagram of one example of both human and machine-executable steps involved in producing a document that combines variable text data and graphics data in accordance with the present invention is shown.

The process begins with a client inquiry (step 202), in reply to which an operator requests the client's zip code and related information (step 204). A modified zip select program is invoked to determine a radius for inclusion based on projected number of weekly bankruptcies (from historical average) and the number of customer fliers the dealer wants generated (step 206). The client dealer than chooses desired parameters, including weeks since filing (step 208) and the operator keys these parameters into the customer data retrieval program (step 210). The data retrieval software may be invoked to identify and retrieve the customers who fit client's selected parameters, as discussed with reference to FIG. 4 (step 212). The client and operator may then discuss and agree upon several factors including: number of customer fliers to be generated, when they will be generated, pricing, etc. (steps 214-215).

The layout and context of the client flier is then discussed and agreed on (step 218). Mock-ups are preferably created in a desktop publishing program or the like such as Illustrator as discussed above. With a set frequency, for example but not necessarily, weekly or monthly, a customer data retrieval operation is invoked (step 220). The retrieved data is merged with the client template (step 222) as discussed above. The merged documents and the selected graphics file are sent to the print engine where a RIP operation is invoked to overlay (or otherwise combine) each merged document onto the selected graphics file. The resultant files are then printed as discussed with reference to FIG. 6 (step 224). The printed fliers may then be folded and/or stuffed into envelopes and sent to client dealer for mailing (step 226), which the client dealer preferably does from their local post office (step 228).

It should be recognized that the embodiment of FIG. 7 and the other embodiments discussed above are only examples of the present invention, and in no way intended to limit the present invention to same. The present invention may be utilized whenever it is desired to combine variable text data and graphics data in a single print operation. While marketing materials are a prime use, the present invention may be used for other purposes including, but not limited to public service announcements, municipal or other government notices, invitations, etc. The variable text data may be other than name and/or contact information.

While the invention has been described in connection with specific embodiments thereof, it will be understood that it is capable of further modification, and this application is intended to cover any variations, uses, or adaptations of the invention following, in general, the principles of the invention and including such departures from the present disclosure as come within known or customary practice in the art to which the invention pertains and as may be applied to the essential features hereinbefore set forth, and as fall within the scope of the invention and the limits of the appended claims.

1. A method of producing a printed document having variable text data and graphics data, comprising the steps of:
retrieving from a database a plurality of entrants based on a given parameter to create a variable text data file;
combining said variable text data file with a graphics file in such a manner as to create a plurality of electronic files that each contain data for one of said retrieved entrants and said graphics file; and
printing, in a single print operation, each of said plurality of electronic files.

2. The method of claim 1, wherein said combining step includes the step of creating said plurality of electronic files to have an aggregate file size of over 500 MB.

3. The method of claim 2, wherein said combining step includes the step of creating said plurality of electronic files with a graphics file that has a size of over 1.5 MB.

4. The method of claim 1, further comprising the step of merging, prior to said combining step, said variable text data file with non-variable text data.

5. The method of claim 1, further comprising the step of parsing said plurality of electronic files into a plurality of bundles and separately printing each of said bundles.

6. The method of claim 1, wherein said retrieving step includes the step of retrieving database entrants based on a location parameter and a time parameter.

7. A method of producing a printed document having variable text data and graphics data components, comprising the steps of:
retrieving a plurality of database entrants based on given parameters to create a variable text data file;
merging said variable text data file with non-variable text data to create a merged variable text data file that contains merged data for each of said plurality of retrieved entrants;
combining said merged variable text data file with a graphics file in such a manner as to create a plurality of electronic files that each contain merged data for one of said retrieved entrants and said graphics file; and
printing, in a single print operation, each of said plurality of electronic files.

8. The method of claim 7, wherein said retrieving step includes the step of retrieving database entrants based on a location parameter and a time parameter.

9. The method of claim 7, wherein said retrieving step includes the step of modifying the retrieval parameters to retrieve a different number of entrants compared to a previous retrieval operation.

10. The method of claim 7, wherein said retrieving step includes the step of tagging a retrieved entrant so that said retrieved entrant is not subsequently retrieved for a conflicting use.

11. The method of claim 7, wherein said retrieving step includes the step of tagging a retrieved entrant based on time.

12. The method of claim 7, wherein said combining step includes the step of overlaying said merged variable text data file on said graphics file to create said plurality of electronic files.

13. The method of claim 7, wherein said combining step includes the step of performing a raster image processing function to combine said merged variable text data file with said graphics file to create said plurality of electronic files.

14. The method of claim 7, further comprising the step of parsing said plurality of electronic files.

15. A method of producing a printed document having variable text data and graphics data, comprising the steps of:
retrieving from a database a plurality of entrants based on a location parameter and a time parameter to create a variable text data file;
merging said variable text data file with non-variable text data to create a merged variable text data file that contains merged data for each of said plurality of retrieved entrants;
performing a raster image processing function to combine said merged variable text data file with a graphics file in such a manner as to create a plurality of electronic files that each contain merged data for one of said retrieved entrants and said graphics file; and
printing, in a single print operation, each of said plurality of electronic files.

16. The method of claim 15, wherein said retrieving step includes the step retrieving name and contact information for each of said entrants.

17. The method of claim 15, wherein said retrieving step includes the step of modifying the retrieval parameters to retrieve a different number of entrants compared to a previous retrieval operation.

18. The method of claim 15, wherein said retrieving step includes the step of retrieving entrants based on a time parameter of weeks after filing for bankruptcy.

19. The method of claim 15, including the step of initiating said retrieving step with a given frequency.

20. A method of combining variable text recipient data and graphics data to produce targeted recipient material on behalf of a sending party, comprising the steps of:
providing a database of recipient data;
determining with sending party the parameters by which to retrieve recipient data from said database;
determining with said sending party a pricing arrangement for generation of printed electronic files based on determined parameters;
retrieving from said database a plurality of recipients based on said determined parameters to create a variable text recipient data file;
merging said variable text recipient data file with non-variable text data to create a merged variable text data file that contains merged data for each of said plurality of retrieved recipients;
combining said merged variable text data file with a graphics file in such a manner as to create a plurality of electronic files that each contain merged data for one of said retrieved recipients and said graphics file; and
printing, in a single print operation, each of said plurality of electronic files.

21. The method of claim 20, further comprising the steps of folding said plurality of printed electronic files and stuffing said folded plurality into envelopes for mailing.
